(19) United States
(12) Patent Application Publication
(10) Pub. No.: US 2018/0012579 A1
(43) Pub. Date: Jan. 11, 2018

(54) LAMINATED PLECTRUM FOR CHORDOPHONE INSTRUMENT

(71) Applicant: Mike MILTIMORE, Kamloops (CA)

(72) Inventor: Mike MILTIMORE, Kamloops (CA)

(21) Appl. No.: 15/543,940

(22) PCT Filed: Jan. 14, 2016
(86) PCT No.: PCT/IB2016/050179

§ 371 Date: Jul. 14, 2017

Related U.S. Application Data
(60) Provisional application No. 62/103,618, filed on Jan. 15, 2015.

(51) Int. Cl. G10D 3/16

(52) U.S. Cl. CPC G10D 3/163

(57) ABSTRACT

A pick for use with a musical instrument is provided, the pick comprising at least three layers, an upper layer having a long vector, a lower layer having a long vector and an amorphous layer, the long vectors aligned with a longitudinal axis of the pick, the upper layer and the lower layer sandwiching and adhered to the amorphous layer to provide a flexible, resilient pick. The pick may have two pick points, normal to one another. As the direction of the long vector controls the feel of the pick, the first pick point will be more rigid and the second pick point will be more flexible. This also causes the first pick point to feel thicker and the second pick point to feel thinner, despite being substantially the same thickness. These features manifest themselves as differences in tone and attack.

### CROSS REFERENCE TO RELATED APPLICATIONS

This application is related to, and claims the benefit of U.S. Provisional Patent Application No. 62/103,618, filed Jan. 15, 2015. The above-identified priority patent application is incorporated herein by reference in its entirety.

### FIELD

The present technology is a plectrum or pick that includes at least two layers that have long vectors and at least one layer that is amorphous, wherein the layers are laminated together. More specifically, the present technology is a laminated pick that provides two tips, which in use, one with the long vector normal to the strings and one with the long vector parallel to the strings.

### BACKGROUND

Guitar picks are often used when a musician is playing a guitar. The pick is held between the thumb and first finger. There is a rounded proximal end and a pointed distal end. This pointed distal end is used to deflect and release the guitar strings. Picks are commonly made of synthetic materials and may be stiff or flexible. Some designs include multiple round apertures as design features. Others, such as disclosed in U.S. Pat. No. 7,459,620, provide a central opening which is slotted open to permit the pick to be stored on pegs and posts on the guitar. The guitar pick is formed of flexible synthetic polymeric material and has a pick point for picking the guitar strings. The body of the guitar pick is sufficiently large to hold between the thumb and forefingers for its manipulation. The body has a central opening that has smooth profile walls and is slotted away from the pick point. The central opening and the slot, together with the flexibility of the pick is sufficient to permit it to be snapped onto and off of pegs and posts on the guitar for storage and retrieval. It is stated that the aperture with its smooth profile walls also permits the musician to firmly and comfortably grasp the pick. The use of a single layer in constructing the pick results in inferior sound, wear in and tone. Further, the slotted opening significantly reduces the strength of the pick, predisposing it to break along an axis defined by the slot. Still further, smooth profile edges on the opening do not contribute well to the user being able to grasp the pick.

Another approach to storage and reduction of slippage is disclosed in U.S. Pat. No. 6,835,881. A guitar pick having a key ring hole for selective attachment to a key ring, and also having a centrally-located disc constructed from non-slippery material, in order to prevent the pick from slipping from a user's fingers while the pick is being used to play a guitar. The disc is substantially flush with the front surface of the pick. The key ring hole is lined on both the front and rear surfaces of the pick with a raised bushing, in order to prevent the key ring hole from cracking or splitting after repeated use. When not being used to play a guitar, the guitar pick may be stored upon the key ring, in order to prevent the pick from becoming misplaced. The opening is not for assisting a user to grasp the pick. Although the disc is supposed to assist in the user grasping the pick, the material used for the disc is not disclosed. No attempt is made to improve the quality of sound, flexibility, tone and wear in of the pick.

Picks that are made from synthetic materials tend to produce an inferior sound. This can be improved by taking steps to alter the flexibility of the pick edges. In U.S. Pat. No. 4,228,719 a pick that has a plurality of rounded corners each adapted for selectively engaging the strings of a musical instrument and each having a degree of flexibility different from that of the others is disclosed. Resilient plastic is molded into a single piece with holes adjacent at least two of the playing corners with the holes being of different sizes so that the playing corners have different flexibility. No attempt is made to improve the quality of sound, flexibility, tone and wear in of the pick.

Wood picks provide a superior tone and volume, however, they tend to crack unless they are thick. The thicker the pick, the less flexible it is, and hence the advantages in terms of tone and volume are lost. Plywood picks are brittle and crack easily.

United States Patent Application 20140090540 discloses a pick for a stringed musical instrument, the pick having a substantially triangular shape and a top edge and two side edges that converge toward a tip. The tip may be used for strumming or picking a stringed instrument. The projection extends from one of the two side edges and contains an enlarged head disposed on its distal end. The enlarged head may be used for tapping or hammering the strings of a musical instrument. In use, the pick may be grasped along the top edge for strumming or picking and it may be rotated approximately ninety degrees to place the head on the projection into contact with strings on the musical instrument while the user grasps the other side edge. The pick is made of a plastic polymer or nylon. No attempt is made to improve the quality of sound, flexibility, tone and wear in of the pick.

United States Patent Application 20130104722 discloses a multi-purpose plectrum that includes a first lobe, a second lobe, a third lobe, a recessed edge, and a convex edge. Grasping the plectrum with the recessed edge resting against the web between the thumb and forefinger of a user's hand allows the user to strum or pluck a string of a string instrument with either the third lobe or the convex edge. The plectrum may also be grasped to allow a user to strum or pluck one or more strings of a string instrument with the first lobe and the second lobe. No attempt is made to improve the quality of sound, flexibility, tone and wear in of the pick.

United States Patent Application 20100180748 discloses a plectrum or pick that is used to strum or pick the strings of guitars, bass guitars, ukuleles, mandolins or other stringed instruments. This pick has apertures disposed therethrough at predetermined locations. Such apertures provide a gripping means which enables a user to grasp and control such pick. The device makes it less likely that a user will drop or lose his or her pick while playing. The apertures provide finger to thumb contact, allowing the musician to better manage the pick in their hands. The apertures may be surrounded by a rim to improve grip. The pick are made of plastic, metal or a combination thereof—it is not disclosed how a combination would be used. No attempt is made to improve the quality of sound, flexibility, tone and wear in of the pick.

DE102006054252 discloses plectra with a wide range of aperture shapes. These are to improve the user's grip. Also disclosed are plectra made of three layers. The inner layer is disclosed as potentially being a precious stone, or a gel or a rubber member. The inner layer is also disclosed as a central support layer made of several different materials. Further, it is disclosed that the inner layers, if of different colours can be visible as in plywood (but are not plywood). Particularly steel (silver, platinum) and gold layers can be used. Precious metals are also suitable so that jewellery is the usable functional element. It is known that gold or other precious metals can generate a special advantageous sound. The objective of these plectra are to improve the user's grip and for the plectra to be decorative or function as jewellery. Little or no attention is paid to improving quality of sound, flexibility, tone and wear in of the pick by selection of long vector direction or long vector layers.

What is needed is a laminated pick that provides excellent grip for the user, is flexible, has very good “wearing in” attributes and can be customized. Preferably, the layers of the laminated pick would be arranged so that the grains of the layers have specific orientations relative to one another. It would also be preferable if the effective thickness of the pick could be altered by altering the grain direction. Preferable, the pick would provide at least two pick contact tips or contact surfaces that provide different tones or attacks. Preferably, the tip of the pick would be dipped or otherwise coated in a layer that would make the tip either softer, for use with a ukulele, where a soft sound is desired, or harder, for when a harder sound is desired. It would be desirable for the pick to have a small slotted aperture for hanging the pick on a string, while not impacting on the integrity of the pick. Also preferably, the picks would be provided on point-of-sale cards.

### SUMMARY

The present technology utilizes specific orientations of the grain of layers of wood veneer coupled with an amorphous layer to provide picks with superior flexibility, wear in, and tone. Parallel orientation of the grain results in a very flexible pick, while perpendicular orientation provides more rigidity. Using layers of wood having different densities or hardness allows for contact surfaces having different characteristics. For example, using a soft wood on a first side and a harder or more dense wood on a second side would provide a hard attack on the first side and a warm attack on the second side. A further attribute of the pick is attained by having more than one pick point. Having a first pick point at the end of the body and a second pick point on the side of the body combined with specific orientations of the grain of the wood veneer results in pick points with different characteristics. For example, if the grain of the wood is oriented along a longitudinal axis of the body of the pick, then the first pick point will be more rigid than the second pick point. Similarly, the “effective thickness” of a pick can be altered by altering the direction of the grain. If the grain is parallel to the longitudinal axis the pick will have a thicker effective thickness and if it is normal to the longitudinal axis it will have a thinner effective thickness. By coating the pick point the characteristics of the pick can be altered to being a softer attack or a harder attack, while retaining the characteristics of wood.

In one embodiment, a pick for use with a musical instrument is provided, the pick comprising at least three layers, an upper layer having a long vector, a lower layer having a long vector and an at least one amorphous layer, the long vectors aligned with a longitudinal axis of the pick, the upper layer and the lower layer sandwiching and adhered to the at least one amorphous layer to provide a flexible, resilient pick. The pick may have two pick points, normal to one another. As the direction of the long vector controls the feel of the pick, the first pick point will be more rigid and the second pick point will be more flexible. This also causes the first pick point to feel thicker and the second pick point to feel thinner, despite being substantially the same thickness. These features manifest themselves as differences in tone and attack.

In another embodiment, a pick for use with a musical instrument is provided, the pick comprising an at least three layers, an upper layer having a long vector, a lower layer having a long vector and an at least one amorphous layer, the long vectors either aligned with a longitudinal axis of the pick or normal to the longitudinal axis of the pick, the upper layer and the lower layer sandwiching and adhered to the at least one amorphous layer.

In the pick, the upper layer and the lower layer may be a veneer of an at least one wood, each wood having a grain, the grain defining the long vector.

In the pick, the amorphous layer may comprise a plastic polymer or a paper material.

The pick may further comprise an inner layer of a wood veneer and two amorphous layers interposed between the upper layer and the inner layer and the lower layer and the inner layer.

In the pick, the long vectors may be aligned with the longitudinal axis of the pick.

In the pick, the long vectors may be normal with the longitudinal axis of the pick.

In the pick, the upper layer and the lower layer may be different woods having different flexibilities. In the pick, the upper layer and the lower layer may be maple.

In the pick, the upper layer, the inner layer and the lower layer may be walnut.

In the pick, at least one amorphous layer may be a compounded fiber paper.

In the pick, at least one amorphous layer may be a polyethylene terephthalate layer.

In the pick, at least one amorphous layer may be a polyvinyl acetate layer.

The pick may comprise: i) a body including: a distal end; a proximal end; a first edge; a second edge, the first and second edges converging to the distal end to define a first pick point; a first side; a second side; and ii) a fin, the fin continuous with the body and extending outwardly from the first edge to define a second pick point normal to the first pick point.

The pick may comprise: i) a body including: a distal end; a proximal end; a first edge; a second edge, the first and second edges converging to the distal end to define a pick point; a first side; and a second side.

The pick may further comprise a central aperture in the body of the pick, wherein the central aperture extends through the body from the first side to the second side and has an irregular perimeter.

The pick may further comprise a slot and an aperture in a vicinity of the proximal end, the slot extending from the proximal end to the aperture and being continuous with the aperture.

The pick may further comprise a hard or a soft tip coating.

In the pick, the hard coating may comprise a mixture of an at least one metal and a plastic polymer.

In the pick, the at least one metal may be graphite.

In the pick, the soft coating may be silicone.

In another embodiment, a pick for use with a musical instrument is provided, the pick comprising a body, the body including a distal end; a proximal end; a first edge; a second edge, the first and second edges converging to the distal end to define a pick point; a first side; and a second side, characterized in that the pick comprises an at least two layers of veneer and an at least one amorphous layer interposed between and adhered to the at least two layers of veneer, each layer of veneer having a long vector, at least one long vector aligned parallel to a longitudinal axis of the body.

The pick may further comprise a central aperture in the body of the pick, wherein the central aperture extends through the body from the first side to the second side and has an irregular perimeter.

The pick may further comprise a slot and an aperture in a vicinity of the proximal end, the slot extending from the proximal end to the aperture and being continuous with the aperture.

The pick may comprise five layers: an upper layer having a long vector, a lower layer having a long vector, an inner layer having a long vector, a first amorphous layer and a second amorphous layer, the two amorphous layers interposed between the upper, middle and lower layers.

In the pick, the inner layer may have a long vector normal to a longitudinal axis of the body of the pick and the upper and lower layers each have a long vector parallel to the longitudinal axis of the body.

In the pick, the inner layer, the upper layer and the lower layer may be a walnut veneer.

In the pick, the amorphous layers may be a paper material.

The pick may further comprise a hard or a soft tip coating.

In the pick, the hard coating may comprise a mixture of an at least one metal and a plastic polymer.

In the pick, the at least one metal may be graphite.

In the pick, the soft coating may be silicone.

In another embodiment, a pick for use with a musical instrument is provided, the pick comprising a wood veneer layer having a long vector and a first structured amorphous layer adhered to the wood veneer layer, the long vector aligned with a longitudinal axis of the pick or normal to the longitudinal axis of the pick.

In the pick, the first structured amorphous layer may comprise a plastic polymer.

In the pick, the plastic polymer may be polyoxymethylene.

The pick may further comprise a second structured amorphous layer, the first and second amorphous layers sandwiching and adhered to the wood veneer layer.

In the pick, the second structured amorphous layer may comprise a plastic polymer.

In the pick, the plastic polymer may be polyoxymethylene.

In yet another embodiment, a point-of sale card is provided, the point-of-sale card comprising an at least one wood veneer layer and an at least one amorphous layer adhered to the wood veneer layer, the card including a card body, a plurality of picks, and a plurality of stems, each pick retained on the card body with a stem, and each pick separated from the card body by a cut intercepted by the stem.

The point-of sale card may comprise the picks described above.

### FIGURES

FIG. 1 is a plan view of an embodiment of the present technology.

FIG. 2 is a median cross sectional view of the technology of FIG. 1.

FIG. 3 is a schematic of the embodiment of FIG. 1.

FIG. 4 is a cross sectional view of an embodiment of the present technology.

FIG. 5 is a cross sectional view of an alternative embodiment of the present technology.

FIG. 6 is a cross sectional view of yet another embodiment of the present technology.

FIG. 7 is a cross sectional view of yet another embodiment of the present technology.

FIG. 8 is a cross sectional view of yet another embodiment of the present technology.

FIG. 9 is a plan view of an alternative embodiment of the present technology.

FIG. 10 is a median cross sectional view of the technology of FIG. 9.

FIG. 11 is a plan view of a point-of sale card of the present technology.

### DESCRIPTION

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, The terms “comprising,” “having,” “including,” and “containing” are to be construed as open-ended terms (i.e., meaning “including, but not limited to,”) unless otherwise noted.

To the extent necessary to provide descriptive support, the subject matter and/or text of the appended claims is incorporated herein by reference in their entirety.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

All methods described herein can be performed in any suitable order unless otherwise indicated herein or otherwise clearly contradicted by context. The use of any and all examples, or exemplary language (e.g., “such as”) provided herein, is intended merely to better illuminate the example embodiments and does not pose a limitation on the scope of the claimed invention unless otherwise claimed. No language in the specification should be construed as indicating any non-claimed element as essential.

### Definitions

### Long Vector:

A vector aligned with the length of the fibers or grain. For example, the long vector of a carbon fiber reinforced polymer is aligned with the long fibers, noting that substantially all the long fibers are arranged in one specific orientation and are not randomly arranged. Similarly, the long vector of a fiberglass reinforced polymer is aligned with the long fibres, noting that substantially all the long fibers are arranged in one specific orientation and are not randomly arranged. The long vector in wood is aligned with the length of the grain of the wood. The long vector is used when there are macroscopic differences in a material such that you can define a directionality.

### Long Vector Layer:

A long vector layer is a layer or veneer in which a directionality of the fibers or grain, or the like can be identified. It may include, but is not limited to natural wood, carbon fiber reinforced polymer and fiberglass reinforced polymer veneers. It does not include materials such as oriented strand board, which would be considered as a “non-natural” wood, nor does it include carbon fiber or fiberglass reinforced polymer veneers that lack a long vector.

### Amorphous Layer:

An amorphous layer or veneer is one in which no directionality of the fibers or a grain can be determined (in other words, a disorganized fibrous material) or has no fibers. It may include, but is not limited to paper, cardboard, plastic polymer, urethane, silk, brass, nylon, polyoxymethylene and particle board. The paper material may be made with natural or synthetic fiber, for example, cellulose fibers or plastic fibers. Carbon fiber reinforced polymers and fiberglass reinforced polymers can also be amorphous. The amorphous layer imparts a “toughness” to the pick. It has equal flexibility in all directions and resists cracking when flexed. The amorphous layer is about 1 mm to about 0.4 mm thick, preferably 0.2 mm and all thicknesses therebetween.

### Structural Amorphous Layer:

A structural amorphous layer is one that can be used as one layer of a two layer pick. It includes materials such as brass, plastic polymers, nylon, polyoxymethylene, but does not include materials such as paper that would be readily broken down if contacting the strings. Carbon fiber reinforced polymers and fiberglass reinforced polymers can also form the structural amorphous layer. Polyoxymethylene is an especially suitable structural amorphous layer as it has a low coefficient of friction, resists abrasion and is hygroscopic, although only mildly hygroscopic. The structured amorphous layer is about 1 mm to about 0.4 mm thick, preferably 0.2 mm and all thicknesses therebetween.

### Tip Coating:

A tip coating is a layer that substantially covers the tip and the region in the vicinity of the tip. The tip may be dipped in the coating material. The tip coating can be a soft material, such as, but not limited to silicone or a hard material that includes a filler. The hard materials include, but are not limited to amorphous (chopped or milled for example, but not limited to) carbon fiber reinforced polymer or directional carbon fiber reinforced polymer, amorphous fiberglass fiber reinforced polymer (chopped or milled for example, but not limited to) or directional fiberglass fiber reinforced polymer, graphite in polyurethane, or ground metal, metal powder, or metal filings in a polymer such as polyurethane. An exemplary mixture for hardening the tip is J-B Weld®, which is an epoxy with ground metal or metal powder. It provides a tensile strength of 3960 PSI. Carbon nanotubes, beads, glass beads, plastic beads, and ferrous materials to impart magnetism can also be provided in a plastic polymer to provide a hard material. The tip coating allows for a change in the feel and sound of the pick to one of either softer or harder, while retaining the flexibility of the combination of the long vector layer or layers and the amorphous layer or layers in the remainder of the pick. The tip coating is applied to the tip, or the body in the vicinity of the tip and the tip, or as much as the tip, and the body between the tip and the central aperture. It is preferably applied by dipping the pick in the coating. It similarly can be applied to a pick made of a structural amorphous layer and a long vector layer.

### Effective Thickness:

The effective thickness of a pick is based on the characteristics of a plastic polymeric pick, including the flexibility of the pick. The effective thickness of the pick can be altered by altering the orientation of the long vector layer and through the use of softer or harder woods. Orientation of the long vectors to be parallel to a longitudinal axis of the pick will make the effective thickness greater, while orientation of the long vectors normal to the longitudinal axis of the pick will decrease the effective thickness, relative to the actual thickness of the pick.

### DETAILED DESCRIPTION

In developing the present technology, various combinations of wood veneers were used in various orientation. It was found that if the veneers were glued together, the resultant picks cracked easily, and did not produce the desired tone or wear in characteristics. When an amorphous layer was used in the pick construction, these deficiencies were remedied and the resultant picks had the desired characteristics. The wood veneers were found to have differing flexibilities depending on their orientation relative to the longitudinal axis of the pick. It was found that the grain orientation was the significant parameter, and this was found to be generically, the long vector, as non-wood veneers were also found to have differing flexibilities depending on their orientation relative to the longitudinal axis of the pick. Testing of various amorphous materials and veneers demonstrated that use of hygroscopic materials provided an additional advantage of reducing slippage of the pick in the user's fingers. Non-hygroscopic materials can slip from the user's fingers as the user's fingers usually sweat during playing of the instrument. Wood veneers, polyoxymethylene, polyethylene terephthalate, paper material, and polyvinyl acetate were found to be suitably hygroscopic. As would be known to one skilled in the art, other materials could also provide the desired characteristics.

To summarize, the veneer layers have a long vector that results in flexibility or rigidity depending upon the direction that the long vector is in relation to the longitudinal axis of the pick. They are hygroscopic. The amorphous layer has no vectors and provide resiliency. They are hygroscopic. The structured amorphous layer has the additional feature of being resistant to wear and abrasion. The combinations of the veneer layers and the amorphous layers provide a warm or hard attack, the desired tone and good wear in.

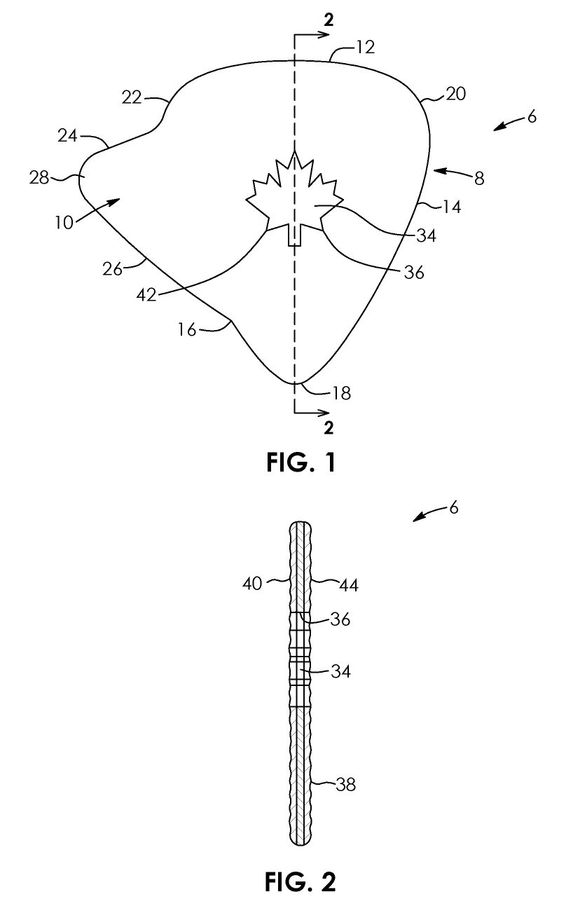

A pick for a musical instrument, generally referred to as 6 is shown in FIG. 1. The pick 6 has body, generally referred to as 8, and a fin, generally referred to as 10. The body 8 has a proximal end 12, a first edge 14 and a second edge 16. The first and second edges 14, 16 converge to a first distal end 18, which is the first pick point. Between the proximal end 12 and the first and second edges 14, 16 are a first shoulder 20 and a second shoulder 22 which are curved to a large radius. The proximal end 12 may be curved or straight. The first and second edges 14, 16 curve inward slightly towards the first distal end 18. The fin 10 is continuous with and extends outward from the body 8 at one of the first or second edges 14, 16. The fin 10 has an upper edge 24 and a lower edge 26 that converge to a second distal end 28, which is the second pick point.

A centrally located aperture 34 in the body 8, has an irregular perimeter 36, with angular direction changes resulting in points 42 or jags or fingers extending into the sides 38, 40. In the disclosed embodiment, the aperture 34 defines a maple leaf. This has a plurality of direction changes that include right angles, acute angles and obtuse angles for a total of 26 angle changes. As shown in FIG. 2, the centrally aperture 34 extends through the pick 6 from the first side 38 to the second side 40. Also shown in FIG. 2, is surface contour 44 on the sides 28, 30. This irregular surface is a result of the wood grain.

The pick 6 is a uniform thickness between about 0.3 mm deep to about 3 mm deep and all thicknesses therebetween. The dimensions for the length and breadth are about 15×15 mm or about 40×40 mm and all ranges therebetween. The aperture 34, while being irregular, can be measured to be about 3 to about 5 mm in diameter or about 4 mm in diameter or about 8 mm in diameter, and all ranges therebetween.

The depth of the pick 6 allows it to withstand the force of a user playing a string, while at the same time providing for the desired flexibility. The central aperture 34 further contributes to the flexibility, allowing the depth to be somewhat thicker than it would be to provide the resultant flexibility. The use of wood also contributes to the flexibility. The result is a pick 6 that provides a warm pick attack, a louder tone than a synthetic pick or plastic polymer pick and good wear-in attributes.

The pick 6 provides superior grip for the user. This is in part a result of the central aperture 34 with its irregular perimeter 36. A user's finger and thumb can press against each other in the aperture to provide one aspect of the superior grip—doing so against an irregular perimeter greatly enhances the grip. Without being bound to theory, this is a result of the large perimeter 36, relative to a shape, for example, such as a circle. Using 8 mm diameter as an example, one can see that the length of the perimeter is at least about 1.25 or about 1.44 times that of a circular aperture defined as having a diameter equivalent to the widest point of the pick (36.3 mm for the perimeter and a circumference of 25.12 mm). This means that the irregular perimeter provides a much longer edge than would a simple shape such as a circle, and this edge provides a gripping surface. One can clearly see that the ratio of perimeter to area of the central aperture is higher for the central aperture with an irregular perimeter than it would be for a circular aperture or a square aperture having a diameter of 8 mm or width of 8 mm, respectively.

The circularity of a circle is 1 and the circularity of a complex shape can approach 0. The circularity of the central aperture is between about 0.0 to about 0.6 or about 0.1 to about 0.4, or about 0.2 to about 0.3 and all ranges therebetween.

The superior grip is also a result of the angular direction changes 42 in the perimeter 36 that result in a complex geometric shape, thereby providing gripping surfaces. Another contributor to grip is the surface contour 44, which is a result of the wood grain or the long vectors in other veneers.

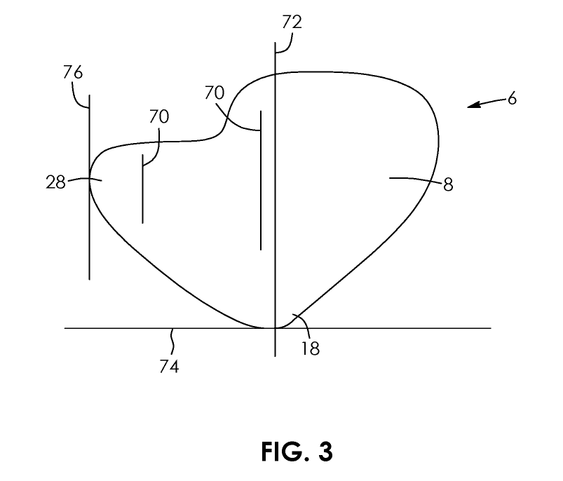

As shown in FIG. 3, the long vector 70 is parallel to the longitudinal axis 72 of the body of the pick 6 in at least two layers. Thus the first pick point 18 has the grain normal to a first tangent line 74 and the second pick point has the grain parallel to a second tangent line 76. This results in differing flexibilities at the pick points, with the first pick point 18 providing the feel of a 1 mm thick pick and the second pick point 28 providing the feel of a 0.3 mm thick pick. This allows a user to have two different pick points that provide two different feels and tones in one pick of substantially consistent thickness.

In the preferred embodiments, the pick 6 is made from natural wood veneer, which may be, for example, but not limited to maple, spruce, cedar, mahogany, rosewood, sapele, cherry, koa, alder, walnut, basswood, agathis, or poplar and an amorphous material in one or more layers. In other embodiments, other materials may be used, for example, carbon fibre reinforced polymer or fibreglass reinforced polymer or the like—essentially any suitably flexible and strong material in which a long vector can be defined that impacts on the rigidity and flexibility of the material, with alignment of the long vectors leading to flexibility and arrangement of the long vectors normal to one another results in rigidity.

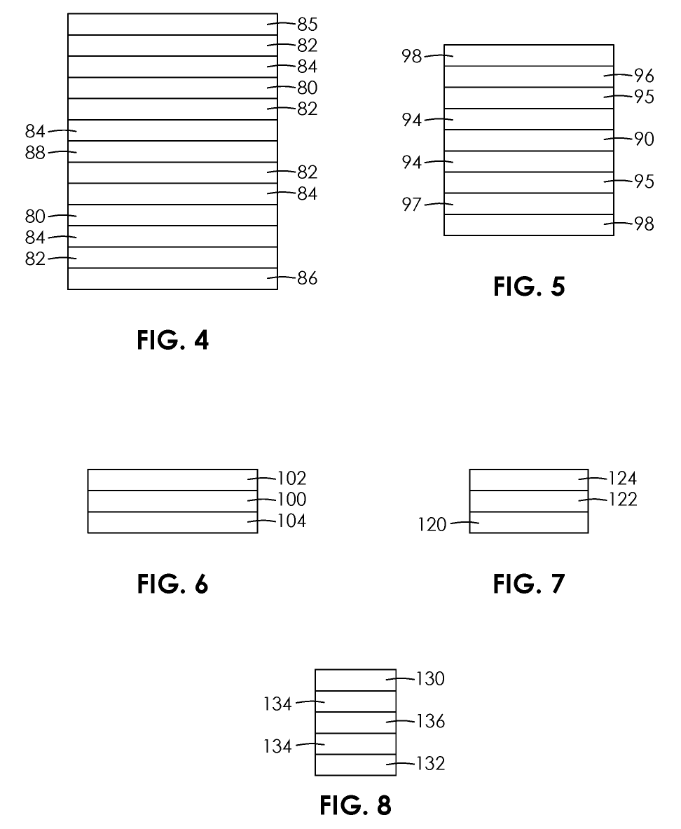

In one embodiment, as shown in FIG. 4, the pick 6 is a five layer pick 6. It is made of two layers of a paper material 80, which in the preferred embodiment is about 0.25 mm compounded fiber paper with a very thin backer 82 with a thermos-set dry film adhesive 84 applied, each layer sandwiched between two layers of walnut veneer, for a total of three layers of walnut veneer 85, 86, 88. The walnut veneer 85, 86, 88 is between about 0.2 mm thick to about 0.30 mm thick including the backer 82. Referring to FIG. 3, the outer two layers (the upper layer 85 and the lower layer 86) of the walnut veneer are oriented with the long vector 70 parallel to the longitudinal axis 72 of the body of the pick 6, hence the grain is oriented to be normal to the first tangent line 74. The inner layer 88 of the walnut veneer is oriented with the long vector normal to the longitudinal axis of the body of the pick, hence the grain is oriented to be parallel to the first tangent line 74. The paper material 80 is the amorphous material. The alignment of the long vectors of the upper 85 and lower layers 86 contribute to the flexibility of the pick. The combination of the paper material and the wood veneer greatly increases the flexibility of the pick and provides a warm attack. In particular, the paper layers 80 add resilience to the pick 6. The inner layer 88 adds rigidity. The pick 6 may have the fin 10 or not have the fin 10, in other words, it may only be the body 8. If there is only the body, then the direction of the long vector is defined in relation to the longitudinal axis of the pick, as the pick is the body.

In another embodiment, as shown in FIG. 5, the pick 6 is made of one layer of a 2 mm plastic polymer layer 90, which is preferably a polyethylene terephthalate layer 90 with a thermos-set dry film adhesive 94 applied. The layer is sandwiched between two layers 96, 97 of maple veneer, for a total of three layers. The veneer is approximately 0.28 mm thick with the #160 backer 95. The maple veneer has a scratch resistant overlay 98.

Referring to FIG. 3, both the upper layer 96 and the lower layer 97 of the maple veneer are oriented with the long vector 70 parallel to the longitudinal axis 72 of the body of the pick 6, hence the grain is oriented to be normal to the first tangent line 74. As the grains are parallel, the pick is flexible. The polyethylene terephthalate layer 90 is the amorphous material. The plastic polymer layer 90 adds resilience to the pick (it is the same material as is used in plastic drink bottles and is very resistant to cracking). The combination of the plastic polymer and the wood veneer therefore increases the flexibility of the pick and provides a warm attack. The pick 6 may have the fin 10 or not have the fin 10, in other words, it may only be the body 8. If there is only the body, then the direction of the long vector is defined in relation to the longitudinal axis of the pick, as the pick is the body. In some cases, it may be preferable to align the long vector with the axis normal to the longitudinal axis (this can be referred to as the horizontal axis). As described above, the feel of a pick with the grain parallel to the horizontal axis will be of a thinner pick, despite the fact that the pick is substantially equivalent thickness throughout. It also gives a rough edge that catches the strings and adds another tone as well as feel.

In yet another embodiment, as shown in FIG. 6, the pick 6 is made of a polyvinyl acetate layer 100 of about 0.25 mm thickness, sandwiched between two wood veneer layers 102, 104 of differing flexibility that are between about 0.2 mm thick to about 1 mm thick, for a total of three layers. The two layers may be, for example, but not limited to alder and maple, or birch and maple, or beech and alder. Without being bound to theory, the different densities result in different flexibilities. Both the upper layer 102 and the lower layer 104 of the wood veneer are oriented with the long vector 70 parallel to the longitudinal axis 72 of the body of the pick 6, hence the grain is oriented to be normal to the first tangent line 74. As the grains are parallel, the pick is flexible. The polyvinyl acetate layer 100 is the amorphous material. This layer adds to the resilience of the pick. The combination of the layer 100 and the wood veneer results in a very flexible pick. An advantage of the different flexibilities is that the first side 38 of the pick 6 can produce, for example, a strong down stroke, while the second side 40 of the pick can produce, for example, a light upstroke. Hence, depending on how the pick 6 is held, and used, it can provide a warm attack or a hard attack. The pick 6 may have the fin 10 or not have the fin 10, in other words, it may only be the body 8. If there is only the body, then the direction of the long vector is defined in relation to the longitudinal axis of the pick, as the pick is the body. In some cases, it may be preferable to align the long vector with the axis normal to the longitudinal axis (this can be referred to as the horizontal axis). As described above, the feel of a pick with the grain parallel to the horizontal axis will be of a thinner pick, despite the fact that the pick is substantially equivalent thickness throughout. It also gives a rough edge that catches the strings and adds another tone as well as feel.

In yet another embodiment, as shown in FIG. 7, the pick 6 is a two layer pick. The amorphous layer is a structured amorphous layer 120, preferably polyoxymethylene or nylon. It is about 0.2 mm to about 1.5 mm thick. An adhesive layer 122 attaches the structured amorphous layer to a wood veneer layer 124. The wood veneer layer 124 has a long vector 70 that is parallel to the longitudinal axis 72 of the pick 6. Alternatively the long vector 70 is normal to the longitudinal axis 72 of the pick 6. The combination of the layer 120 and the wood veneer 124 results in a moderately flexible pick that has good resiliency. The wear in is good as is the tone. The wood veneer may be, for example, but not limited to, alder, maple, birch, walnut or beech. It is about 0.2 mm to about 2.7 mm thick.

In yet another embodiment, as shown in FIG. 8, the pick 6 is a three layer pick. There is an upper or first structured amorphous layer 130 and a lower or second structured amorphous layer 132. They are preferably polyoxymethylene or nylon and are between about 0.2 mm to about 0.5 mm thick. An adhesive layer 134 attaches the structured amorphous layers to a wood veneer layer 136. The wood veneer layer 136 has a long vector 70 that is parallel to the longitudinal axis 72 of the pick 6. The combination of the layers results in a relatively resilient pick that has limited flexibility. The wear in is good as is the tone. The wood veneer may be, for example, but not limited to, alder, maple, birch, walnut or beech. It is between about 0.2 mm to about 0.6 mm thick. Alternatively the long vector 70 is normal to the longitudinal axis 72 of the pick 6. This provides a more flexible pick.

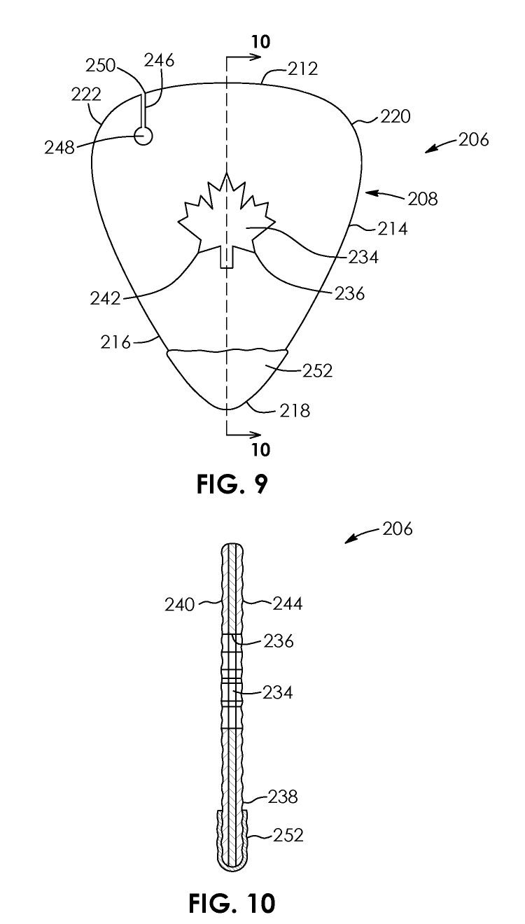

In another embodiment, a different pick shape is provided, as shown in FIG. 9. This pick 6 can be manufactured using any of the veneers and combinations of long vector layers and amorphous layers and long vector layers and structured amorphous layers described above.

The pick, generally referred to as 206 has a body, generally referred to as 208 with a proximal end 212, a first edge 214 and a second edge 216. The first and second edges 214, 216 converge to a distal end 218, which is the pick point or tip. Between the proximal end 212 and the first and second edges 214, 216 are a first shoulder 220 and a second shoulder 222 which are curved to a large radius. The proximal end 212 may be curved or straight. The first and second edges 214, 216 curve inward slightly towards the first distal end 218.

A centrally located aperture 234 in the body 208, has an irregular perimeter 236, with angular direction changes resulting in points 242 or jags or fingers extending into the sides 238, 240. In the disclosed embodiment, the aperture 234 defines a maple leaf. This has a plurality of direction changes that include right angles, acute angles and obtuse angles for a total of 26 angle changes.

As shown in FIG. 10, the centrally aperture 234 extends through the pick 206 from the first side 238 to the second side 240. Also shown in FIG. 10 is surface contour 244 on the sides 228, 230. This irregular surface is a result of the wood grain. A slot 246 extends from the proximal end 212 through the body 208 of the pick 206. It terminates in a small aperture 250 in the vicinity of the proximal end 212. The slot 246 and aperture 250 are sized to accept a string. This allows the pick 206 to be retained on a string when not in use. The aperture 250 and slot 246 are small so as not to impact on the integrity of the pick 206 and to not impact on the sound made by the pick 206.

As shown in FIGS. 9 and 10, the tip 18 and the adjacent surface are coated with a tip coating 252. The tip coating 252 is a layer that substantially covers the tip 18 and the region in the vicinity of the tip 18. In one embodiment, the tip coating 252 is applied to the tip 18 and the body 208 between the tip 18 and the central aperture 234. The tip 18 or tip 18 and body 208 between the tip 18 and the central aperture 234 may be dipped in the coating material. The tip coating 18 can be a soft material, such as, but not limited to silicone or a hard material, such as, but not limited to amorphous carbon fiber reinforced polymer, amorphous fiberglass fiber reinforced polymer, graphite in polyurethane, or ground metal or powdered metal or metal filings in a polymer such as polyurethane. An exemplary composition for hardening the tip is J-B Weld®, which is an epoxy with ground metal or metal powder. It provides a tensile strength of 3960 PSI. The tip coating 252 allows for a change in the feel and sound of the pick 206 to one of either softer or harder, while retaining the flexibility of the combination of the long vector layer or layers and the amorphous layer or layers in the remainder of the pick. It similarly can be applied to a pick made of a structural amorphous layer and a long vector layer. It similarly can be used to coat one or more tips of all the embodiments described herein.

The picks 6, 206 are preferably provided in effective thicknesses of 0.3 mm, 0.46 mm, 0.6 mm, 0.8 mm, 1.0 mm, 1.2 mm and in 0.2 mm increments to about 3 mm. A 0.6 mm pick can have an effective thickness of 0.46 mm or of 0.6 mm, by altering the orientation of the long vector layer or layers. If the orientation of the long vector layer or layers is parallel to the longitudinal axis 72, the pick 6 will have the same or similar thickness as effective thickness. If the orientation of the long vector layer or layers is normal to the longitudinal axis 72, the pick 6 will have an effective thickness of less than the actual thickness.

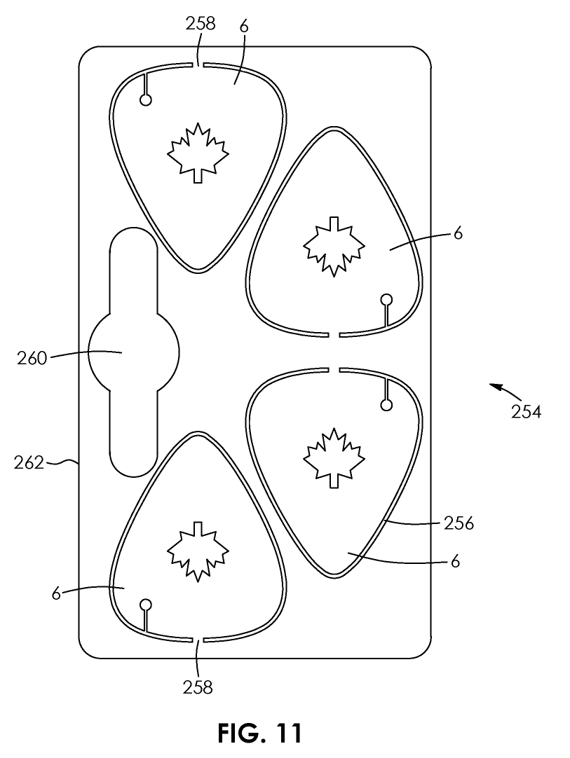

A point-of-sale card, generally referred to as 254 is shown in FIG. 11. The point-of-sale card retains four picks 6, each on a small stem 258 that extends between and is attached to each pick 6 and the card body 262. The card body 262 is therefore made of the same materials as the picks 6 are made. Further, the orientation of the layers in the card body 262 is the same as the orientation of the layers in the picks 6. A hang aperture 260 allows the card 254 to be hung on a display rack. Each pick 6 is separated from the card body by a cut 256 that is intercepted only by the small stem 258. The cut 256 is preferably cut with a laser cutter.

Advantages of the exemplary embodiments described herein may be realized and attained by means of the instrumentalities and combinations particularly pointed out in this written description. It is to be understood that the foregoing general description and the following detailed description are exemplary and explanatory only and are not restrictive of the claims below. While example embodiments have been described in detail, the foregoing description is in all aspects illustrative and not restrictive. It is understood that numerous other modifications and variations can be devised without departing from the scope of the example embodiment.

What is claimed is:

1. A pick for use with a musical instrument, the pick comprising an at least three layers, an upper layer having a long vector, a lower layer having a long vector and an at least one amorphous layer, the long vectors either aligned with a longitudinal axis of the pick or normal to the longitudinal axis of the pick, the upper layer and the lower layer sandwiching and adhered to the at least one amorphous layer.

2. The pick of claim 1, wherein the upper layer and the lower layer are a veneer of an at least one wood, each wood having a grain, the grain defining the long vector.

3. The pick of claim 1, wherein the amorphous layer comprises a plastic polymer or a paper material.

4. The pick of claim 2, further comprising an inner layer of a wood veneer and two amorphous layers interposed between the upper layer and the inner layer and the lower layer and the inner layer.

5. The pick of claim 1, wherein the long vectors are aligned with the longitudinal axis of the pick.

6. The pick of claim 1, wherein the long vectors are normal with the longitudinal axis of the pick.

7. The pick of claim 1, wherein the upper layer and the lower layer are different woods having different flexibilities.

8. (canceled)

9. (canceled)

10. The pick of claim 1, wherein at least one amorphous layer is a compounded fiber paper.

11. The pick of claim 1, wherein at least one amorphous layer is a polyethylene terephthalate layer.

12. (canceled)

13. The pick of claim 1, wherein the pick comprises: i) a body including: a distal end; a proximal end; a first edge; a second edge, the first and second edges converging to the distal end to define a first pick point; a first side; a second side; and ii) a fin, the fin continuous with the body and extending outwardly from the first edge to define a second pick point normal to the first pick point.

14. (canceled)

15. The pick of claim 13, further comprising a central aperture in the body of the pick, wherein the central aperture extends through the body from the first side to the second side and has an irregular perimeter.

16. The pick of claim 13, further comprising a slot and an aperture in a vicinity of the proximal end, the slot extending from the proximal end to the aperture and being continuous with the aperture.

17. (canceled)

18. (canceled)

19. (canceled)

20. (canceled)

21. A pick for use with a musical instrument, the pick comprising a body, the body including a distal end; a proximal end; a first edge; a second edge, the first and second edges converging to the distal end to define a pick point; a first side; and a second side, characterized in that the pick comprises an at least two layers of veneer and an at least one amorphous layer interposed between and adhered to the at least two layers of veneer, each layer of veneer having a long vector, at least one long vector aligned parallel to a longitudinal axis of the body.

22. The pick of claim 21, further comprising a central aperture in the body of the pick, wherein the central aperture extends through the body from the first side to the second side and has an irregular perimeter.

23. The pick of claim 21, further comprising a slot and an aperture in a vicinity of the proximal end, the slot extending from the proximal end to the aperture and being continuous with the aperture.

24. The pick of claim 21, comprising five layers: an upper layer having a long vector, a lower layer having a long vector, an inner layer having a long vector, a first amorphous layer and a second amorphous layer, the two amorphous layers interposed between the upper, middle and lower layers.

25. The pick of claim 21, wherein the inner layer has a long vector normal to a longitudinal axis of the body of the pick and the upper and lower layers each have a long vector parallel to the longitudinal axis of the body.

26. (canceled)

27. (canceled)

28. (canceled)

29. (canceled)

30. (canceled)

31. (canceled)

32. A pick for use with a musical instrument, the pick comprising a wood veneer layer having a long vector and a first structured amorphous layer adhered to the wood veneer layer, the long vector aligned with a longitudinal axis of the pick or normal to the longitudinal axis of the pick.

33. (canceled)

34. (canceled)

35. (canceled)

36. (canceled)

37. (canceled)

38. A point-of sale card, the point-of-sale card comprising an at least one wood veneer layer and an at least one amorphous layer adhered to the wood veneer layer, the card including a card body, a plurality of picks, and a plurality of stems, each pick retained on the card body with a stem, and each pick separated from the card body by a cut intercepted by the stem.

39. The point-of sale card of claim 38 comprising the pick of claim 1.
